(19) United States
(12) Patent Application Publication
(10) Pub. No.: US 2019/0171392 A1
(43) Pub. Date: Jun. 6, 2019

(54) METHOD OF OPERATING STORAGE DEVICE CAPABLE OF REDUCING WRITE LATENCY

(71) Applicant: SAMSUNG ELECTRONICS CO., LTD., Suwon-si (KR)

(72) Inventors: Jin-woo KIM, Seoul (KR); Woo-tae CHANG, Yongin-si (KR); Wan-soo CHOI, Hwaseong-si (KR)

(73) Assignee: SAMSUNG ELECTRONICS CO., LTD., Suwon-si (KR)

(21) Appl. No.: 16/020,581

(22) Filed: Jun. 27, 2018

(30) Foreign Application Priority Data
Dec. 5, 2017 (KR) 10-2017-0166192

(51) Int. Cl. G06F 3/06; G06F 13/28; G06F 13/16

(52) U.S. Cl. CPC G06F 3/0659; G06F 3/0611; G06F 13/1673; G06F 13/28; G06F 3/0673

(57) ABSTRACT

A method of operating a storage device for reducing write latency. The storage device determines whether to support write data support (WDS), fetches a write command selectively including an instant write flag when WDS is supported, updates an address mapping table regarding a controller memory buffer (CMB) without an host direct memory access (HDMA) operation in response to the fetched write command, and generates write command completion message corresponding to the write command.

### CROSS-REFERENCE TO RELATED APPLICATION

This application claims priority from Korean Patent Application No. 10-2017-0166192, filed on Dec. 5, 2017, in the Korean Intellectual Property Office, the disclosure of which is incorporated herein by reference in its entirety.

### BACKGROUND

Methods and apparatuses consistent with embodiments of the present disclosure relate to a storage device, and more particularly, to a method of operating a storage device for reducing a write completion latency and a method of issuing commands by a host.

As techniques of manufacturing semiconductors have developed, the operating speed of a host, e.g., a computer, a smartphone, a smart pad, etc., for communicating with a storage device is increasing. Also, capacity of content used in a host and a storage device is increasing. Accordingly, demand for a storage device having improved performance has been continuously increasing.

### SUMMARY

Aspects of embodiments of the present disclosure provide a method of operating a storage device for reducing a write completion latency and a method of issuing commands by a host.

According to an aspect of an embodiment, there is provided a method of operating a storage device, the method including: receiving a write command issued by the host; updating an address mapping table regarding a controller memory buffer (CMB) of the storage device in response to the write command; generating a write command completion message corresponding to the write command, performed by the CMB, without performing a host direct memory access (HDMA) operation; and transmitting the write command completion message to the host.

According to an aspect of an embodiment, there is provided a method of operating a storage device, the method including: determining whether to support write data support (WDS) of a write command provided by a host; in response to determining that WDS is supported, generating a write command completion message, performed by a controller memory buffer (CMB) of the storage device, corresponding to the write command issued by the host without performing a host direct memory access (HDMA) operation and in response to determining that WDS is not supported, generating a write command completion message after performing the HDMA operation in the CMB in response to the write command issued by the host; and transmitting the write command completion message to the host.

According to an aspect of an embodiment, there is provided a method of issuing a command, performed by a host, the method including: issuing a write command including write data support (WDS) to a storage device; and receiving a write command completion corresponding to the write command, wherein the WDS is a storage operation to store data based on manipulation of an address of the data in a controller memory buffer (CMB) of the storage device.

According to an aspect of an embodiment, there is provided a storage device including: a non-volatile memory; and a controller configured to control the non-volatile memory devices, wherein the controller includes a controller memory buffer (CMB) address swap module that is configured to update an address mapping table regarding the CMB by using a free buffer area in the CMB, in response to a write command including write data support (WDS) provided by a host.

### BRIEF DESCRIPTION OF THE DRAWINGS

Embodiments of the present disclosure will be more clearly understood from the following detailed description taken in conjunction with the accompanying drawings in which:

FIG. 1 is a diagram exemplarily illustrating a host system according to an embodiment;

FIG. 2 is a diagram illustrating a queue interface method of processing commands, according to an embodiment;

FIGS. 3 and 4A-C are diagrams illustrating a write operation of a first example executed in the host system of FIG. 1;

FIGS. 5, 6, 7, and 8A-C are diagrams illustrating a write operation of a second example executed in the host system of FIG. 1;

FIG. 9 is a diagram illustrating a controller memory buffer size according to an embodiment;

FIG. 10 is a diagram illustrating an instant write flag according to an embodiment;

FIG. 11 is a diagram illustrating a write buffer threshold according to an embodiment;

FIG. 12 is a diagram illustrating a method of requesting a write buffer threshold, according to an embodiment;

FIG. 13 is a diagram illustrating notification of asynchronous event information according to an embodiment;

FIG. 14 is a diagram illustrating a method of requesting notification of asynchronous event information, according to an embodiment;

FIG. 15 is a flowchart illustrating a method of setting a write buffer threshold, according to an embodiment;

FIG. 16 is a flowchart illustrating a write operation of a third example executed in the host system of FIG. 1, according to an embodiment;

FIG. 17 is a block diagram of a server system according to an embodiment; and

FIG. 18 is a block diagram of a data center according to an embodiment.

### DETAILED DESCRIPTION OF THE EMBODIMENTS

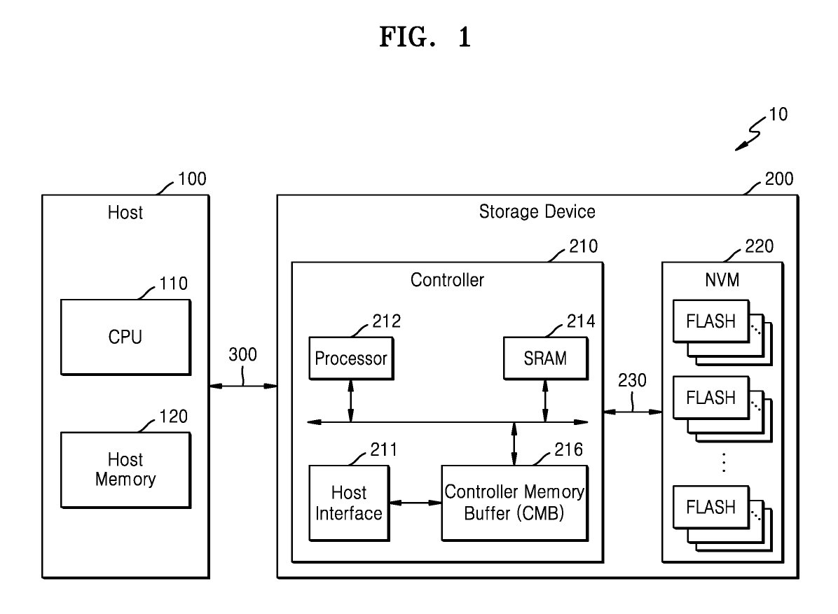

FIG. 1 is a diagram illustrating a host system according to an embodiment.

Referring to FIG. 1, the host system 10 includes a host 100 and a storage device (e.g., non-volatile memory express (NVMe)) 200. The host system 10 may be used as a computer, a portable computer, an ultra-mobile PC (UMPC), a workstation, a data server, a netbook, a personal digital assistant (PDA), a Web tablet, a wireless phone, a mobile phone, a smartphone, an electronic book, a portable multimedia player (PMP), a digital camera, a digital audio recorder/player, a digital camera/video recorder/player, a portable game machine, a navigation system, a black box, a three-dimensional (3D) television, a device for collecting and transmitting information in a wireless environment, one of various electronic devices configuring a home network, one of various electronic devices configuring a computer network, one of various electronic devices configuring a telematics network, a radio frequency identification (RFID) device, one of various electronic devices configuring a computing system, etc.

The host 100 may include a central processing unit (CPU) 110 and a host memory 120. The host 100 may execute one or more of an operating system (OS), a driver, and an application. Communication of the host 100 or the storage device 200 is performed selectively through a driver and/or an application.

The CPU 110 may control overall operations of the host system 10. The CPU 110 may include a plurality of processing cores, and each of the processing cores may include a plurality of processing entries. The CPU 110 may execute data write or read operations performed on the storage device 200 according to the processing entry.

The host memory 120 may store data generated in relation to the processing entry of the CPU 110. The host memory 120 may include a system memory, a main memory, a volatile memory, and a non-volatile memory. The host memory 120 may include volatile and non-volatile, removable and non-removable media implemented in any method or technology for storage of information such as computer-readable instructions, data structures, program modules or other data. Computer storage media includes, but is not limited to, random access memory (RAM), read only memory (ROM), electrically erasable and programmable ROM (EEPROM), flash memory or other memory technology, CD-ROM, digital versatile disks (DVD) or other optical disk storage, magnetic cassettes, magnetic tape, magnetic disk storage or other magnetic storage devices, or any other medium that may be used to store the desired information and may be accessed by the computer system.

The storage device 200 may include a controller 210 and a non-volatile storage 220 (hereinafter, referred to as ‘NVM 220’). The NVM 220 may include a plurality of non-volatile memory (NVM) elements (for example, flash memories). The NVM elements may include a plurality of memory cells, and the plurality of memory cells may be, for example, flash memory cells. When the plurality of memory cells are NAND flash memory cells, a memory cell array may include a 3D memory cell array including a plurality of NAND strings.

The 3D memory array may be formed monolithically in one or more physical levels of arrays of memory cells having an active area disposed above a silicon substrate and circuitry associated with the operation of the memory cells, and such associated circuitry may be above or within such substrate. As used herein, the term “monolithic” means that layers of each level of the array are directly deposited on the layers of each underlying level of the array.

In an embodiment, the 3D memory array may include NAND strings that are vertically oriented, such that at least one memory cell is located over another memory cell. The at least one memory cell may include a charge trap layer. The following documents, which are hereby incorporated by reference in their entireties, disclose exemplary configurations of 3D memory arrays, in which the 3D memory array may be configured as a plurality of levels, with word lines and/or bit lines shared between levels: U.S. Pat. Nos. 7,679,133; 8,553,466; 8,654,587; 8,559,235; and U.S. Patent Application Publication No. 2011/0233648.

The storage device 200 may include a solid state driver (SSD), NVMe SSD, or PCIe SSD. SSD is a high performance and high speed storage device. NVMe is an ultra-high speed data transmission standard optimized for accessing SSDs. NVMe may provide the NVM 220 included in a peripheral component interconnect express (PCIe) interface with direct input/output (I/O) access. The NVM 220 may be implemented as NVMe-over Fabrics (NVMe-oF). NVMe-oF is a flash storage array based on PCIe NVMe SSD, and may be expanded to fabrics capable of performing massive parallel communication.

NVMe is a scalable host controller interface designed to address the needs of enterprises, data centers, and client systems that may employ SSDs. NVMe is typically used as an SSD device interface for presenting a storage entity interface to a host. PCIe is a high-speed serial computer expansion bus standard, and includes higher maximum system bus throughput, lower I/O pin count and smaller physical footprint, better performance-scaling for bus devices, and a more detailed error detection and notification mechanism. NVMe defines an optimized register interface, command set, and feature set for PCIe SSDs, and is positioned to standardize the PCIe SSD interface by using functionality of the PCIe SSDs.

The controller 210 operates as a bridge between the host 100 and the NVM 220 and may execute commands transmitted from the host 100. At least some of the commands may instruct the controller 210 to record and read data transmitted from and transmitted to the host 100 in/from the storage device 200. The controller 210 may perform data record/read transactions with the CPU 110. The controller 210 may control data processing operations (e.g., write operations, read operations, etc.) on the NVM 220 via an NVM interface 230.

The controller 210 may include a host interface 211, a processor 212, an internal memory 214, and a controller memory buffer (CMB) 216.

The host interface 211 provides an interface with the host 100, and may transmit and receive commands and/or data via an external interface 300. According to an embodiment, the host interface 211 may be compatible with one or more of a PCIe interface standard, a universal serial bus (USB) interface standard, a compact flash (CF) interface standard, a multimedia card (MMC) interface standard, an eMMC interface standard, a Thunderbolt interface standard, a UFS interface standard, an SD interface standard, a Memory Stick interface standard, an xD-picture card interface standard, an IDE interface standard, a SATA interface standard, a SCSI interface standard, and a SAS interface standard.

The processor 212 controls overall operations of the controller 210. The processor 212 may process some or all the data transmitted between the CMB 216 and the external interface 300, or data stored in the CMB 216.

The processor 212 may determine whether to support write data (WDS) provided from the host 100. As a result of determination, when WDS is supported, the processor 212 may control the CMB 216 to issue a write command completion corresponding to a write command issued by the host 100, without a host DMA (HDMA) operation. As a result of determining whether to support write data (WDS), when WDS is not supported, the processor 212 may control the CMB 216 to issue a write command completion after performing an HDMA operation in correspondence with the write command issued by the host 100.

The processor 212 may control an address mapping table regarding the CMB 216 to be updated by using a free buffer area in the CMB 216, in response to the write command including the WDS provided by the host 100 and an instant write flag. According to an embodiment, the instant write flag may be an option that is selectively included in the write command.

The processor 212 may receive a threshold value of the free buffer area in the CMB 216 as a write buffer threshold from the host 100, and set the free buffer area in the CMB 126 as the write buffer threshold. The processor 212 may notify the host 100 that the free buffer area in the CMB 216 is below the write buffer threshold.

An internal memory 214 may store data that is necessary in operation of the controller 210 or data generated by the data processing operations (e.g., the write operation or the read operation) performed by the controller 210. The internal memory 214 may store the address mapping table regarding the CMB 216.

According to an embodiment, the internal memory 214 may store some of the CMB address mapping table related to a CMB address targeted by the host 100, from an entire address mapping table regarding the CMB 216. Here, the entire address mapping table regarding the CMB 216 may be stored in another memory device that is separate from the internal memory 214.

According to an embodiment, the internal memory 214 may include, but is not limited to, RAM, dynamic RAM (DRAM), static RAM (SRAM), cache, or a tightly coupled memory (TCM).

The CMB 216 may store data transmitted to/from the external interface 300 or to/from the NVM interface 230. The CMB 216 may have a memory function used to temporarily store data or a direct memory access (DMA) function used to control data transfer to/from the CMB 216. According to an embodiment, the CMB 216 may be used to provide an error correction function of a higher level and/or redundancy function.

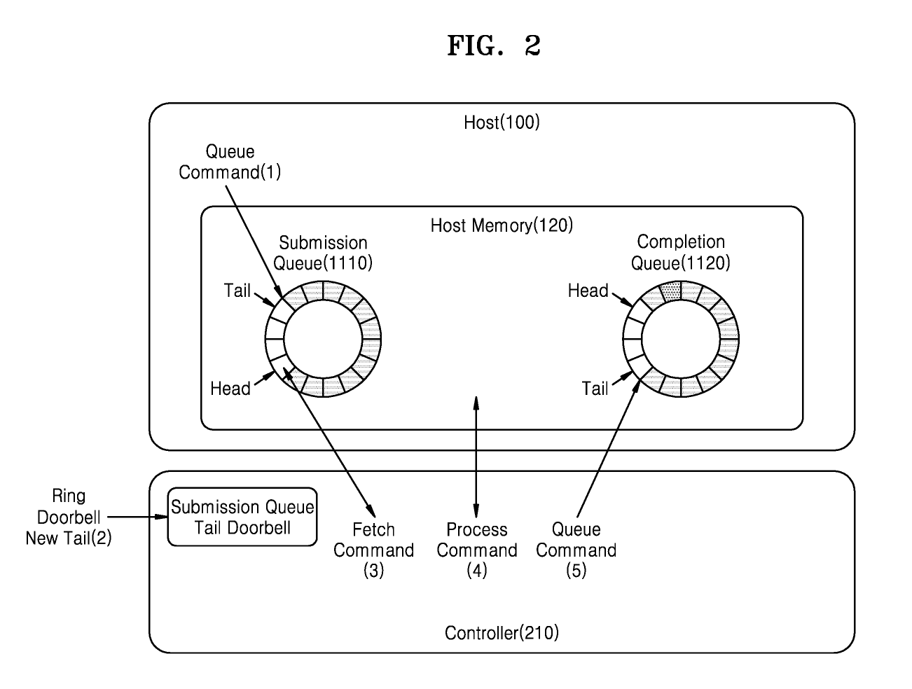

FIG. 2 is a diagram illustrating a queue interface method of processing commands, according to an embodiment.

Referring to FIG. 2, a command queue interface may be performed based on a queue pair including a submission queue (SQ) 1110 for requesting a command and a completion queue (CQ) 1120 for finishing a process of a corresponding command. The host memory 120 of the host 100 may include the SQ 1110 and the CQ 1120 of a ringbuffer type.

The SQ 1110 may store commands that are to be processed in the storage device 200 (see FIG. 1). The SQ 1110 may include a synchronous command (CMD) with a time-out and an asynchronous CMD without a time-out.

As an example, the synchronous CMD may include read/write commands for inputting/outputting data to/from the storage device 200, and ‘set features CMD’ for setting the storage device 200. The set features CMD may include the write buffer threshold, arbitration, power management, LBA Range Type, temperature threshold, error recovery, volatile write cache, interrupt coalescing, interrupt vector configuration, write atomicity normal, asynchronous event configuration, autonomous power state transition, host memory buffer, command set specific, vender specific, supported protocol version, etc.

As an example, the asynchronous CMD may include an asynchronous event request CMD. The asynchronous events may be used to notify software in the host 100 of status information, error information, health information, etc. of the storage device 200. The storage device 200 may notify the host 100 of Below Write Buffer Threshold representing that the free buffer area becomes less than the set write buffer threshold. The storage device 200 may insert Below Write Buffer Threshold in an asynchronous CMD completion corresponding to the asynchronous event request CMD, and notify the host 100 of the asynchronous event request CMD.

First, the CMD queue interface may be performed as follows. The host 100 issues a queue CMD to the SQ 1110 (1). Second, the host 100 notifies an SQ tail pointer to the controller 210 via a tail doorbell ring operation (2). The doorbell ring operation denotes an operation of notifying the controller 210 that there is a new task that needs to be performed for a specified SQ 1110. Third, the controller 210 may fetch the CMD from the SQ 1110 (3). Fourth, the controller 210 may process the fetched CMD (4). Fifth, the controller 210 may notify the CQ 1120 of the CMD completion after processing the CMD (5).

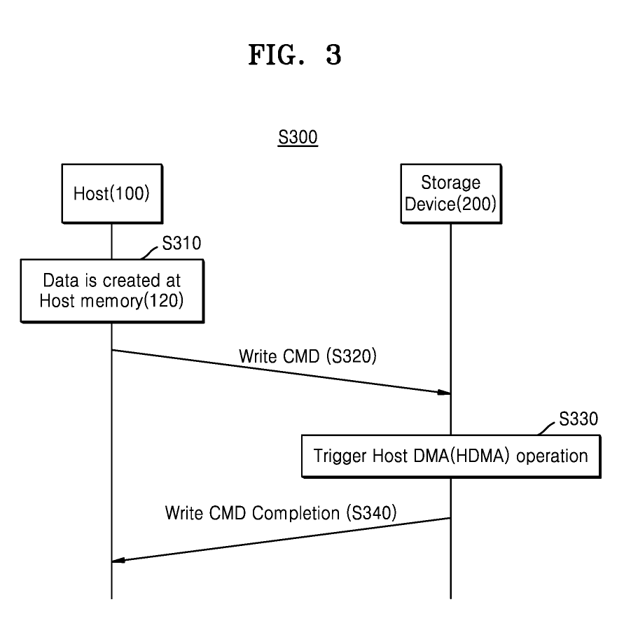

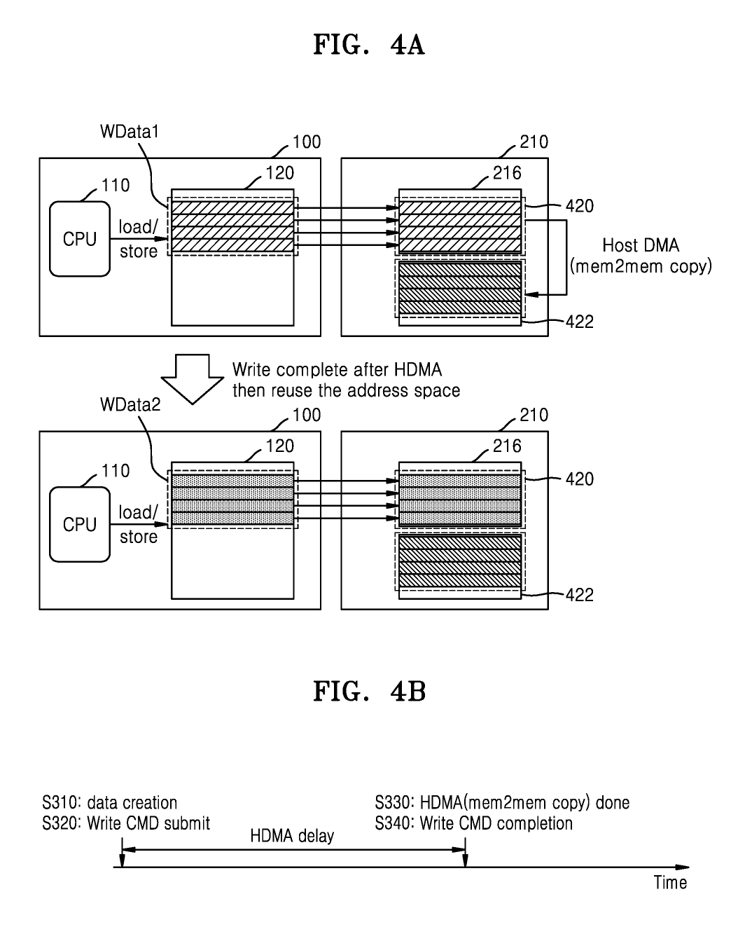

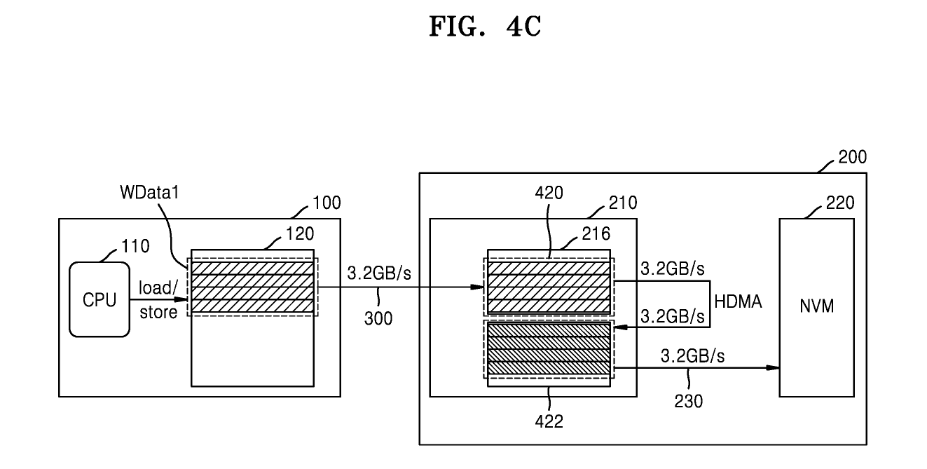

FIGS. 3 and 4A-C are diagrams illustrating a write operation of a first example executed in the host system 10 of FIG. 1.

Referring to FIGS. 1 to 4C, the write operation (S300) includes a host direct memory access (DMA) operation and may be performed as follows.

The host 100 may generate data to be written in the storage device 200 according to a processing entry (S310). The host 100 may issue a write command to the storage device (S320). The storage device 200 may fetch the write command of the SQ 1110, and process the fetched write command. The storage device 200 may process the write command by triggering the host DMA (HDMA) operation (S330). The storage device 200 may transfer a write command completion to the host 100 after processing the write command. The HDMA operation will be described below with reference to FIG. 4A.

Referring to FIG. 4A, first data WData1 generated in the host 100 by a first processing of the CPU 110 is stored in the host memory 120, and the first data WData1 of the host memory 120 may be transferred to the controller 210. The controller 210 stores the first data WData1 in a first memory area 420 of the CMB 216, and may copy the first data WData1 stored in the first memory area 420 of the CMB 216 to a write buffer area 422 of t the controller 210. A memory copy operation (mem2mem copy) of copying the first data WData1 in the first memory area 420 of the CMB 216 to the write buffer area 422 of the controller 210 may occupy most of the HDMA operation.

During the HDMA operation, when the controller 210 transfers the write command completion to the host 100 without performing the memory copy operation (mem2mem copy), the host 100 may reuse the first memory area 420 address of the CMB 216, and in this case, data conflicts may occur in the first memory area 420. To prevent the data conflicts, the memory copy operation (mem2mem copy) for copying the first data WData1 of the first memory area 420 of the CMB 216 to the write buffer area 422 of the controller 210 is necessary in the HDMA operation. The controller 210 may transfer a write command completion to the host 100 after performing the memory copy operation (mem2mem copy).

After receiving the write command completion, the host 100 stores second data WData2 generated by a second processing in the host memory 120, and may transfer second data WData2 in the host memory 120 to the controller 210. The controller 210 may store the second data WData2 in the first memory area 420 of the CMB 216. Here, since the first data WData1 stored in the first memory area 420 of the CMB 216 is moved to the write buffer area 422 of the controller 210, data conflicts do not occur in the first memory area 420 even when the second data WData2 is stored in the first memory area 420.

As shown in FIG. 4B, it may take a significantly long time to finish the memory copy operation (mem2mem copy) after the task request of the write command in the HDMA operation. A long delay time according to the HDMA operation will be reflected as a latency of the write command completion. Long latency of the write command completion may impact high speed performance of the host system 10.

It will be assumed that the write operation of the first data WData1 according to the write command of the host 100 is performed with, for example, 3.2 GB/s bandwidth.

The write operation of the first data WData1 may include, as shown in FIG. 4C, a transferring operation from the host memory 120 to the first memory area 420 of the CMB 216 via the external interface 300 with 3.2 GB/s bandwidth, an output operation from the first memory area 420 of the CMB 216 according to the HDMA operation with 3.2 GB/s bandwidth and an input operation into the write buffer area 422 of the controller 210 with 3.2 GB/s bandwidth, and a transferring operation from the write buffer area 422 of the controller 210 to the NVM 220 via the NVM interface 230 with 3.2 GB/s bandwidth. Accordingly, a buffer bandwidth required by the CMB 216 is 12.9 GB/s (=3.2 GB/s×4). That is, a bandwidth amount of the CMB 216 increases when the HDMA operation is performed, which may be inefficient in view of the memory performance of the CMB 216.

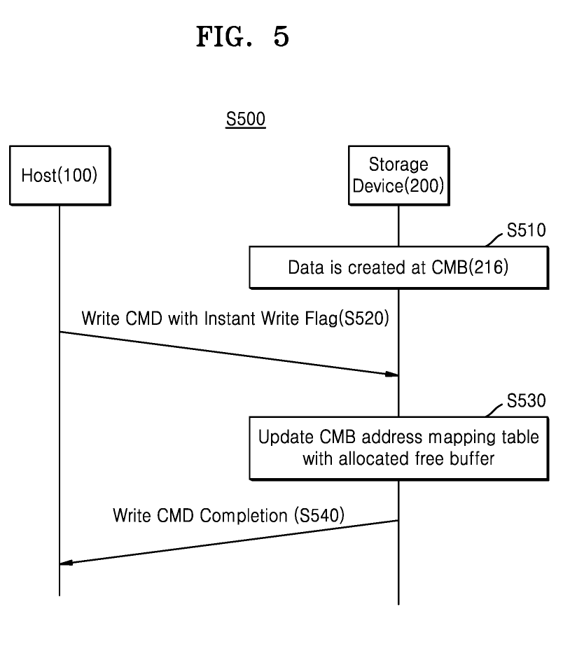

When the HDMA operation may be omitted in the write operation illustrated in FIGS. 3 to 4C, the write command completion latency would be reduced and the CMB 216 may be efficiently used. Methods of operating the storage device 200, capable of omitting the HDMA operation, will be illustrated in FIGS. 5 to 8C.

FIGS. 5 to 8C are diagrams illustrating a write operation of a second example executed in the host system of FIG. 1.

Referring to FIGS. 5 to 8C, the write operation may be performed as follows without performing the HDMA operation.

Referring to FIG. 5 together with FIGS. 1 and 2, the write operation of the storage device 200 capable of omitting the HDMA operation (S500) may be performed as follows.

The storage device 200 may store data to be written in the storage device 200 in the CMB 216 due to data communication performed with the host 100 (S510). Prior to operation S510, the storage device 200 may store the first data WData1 provided from the host 100 in the CMB 216.

The host 100 may issue a write command including an instant write flag to the storage device 200 (S520). The host 100 determines whether the data to be written on the storage device 200 is stored in the CMB 216, and then may issue the WDS and the instant write flag. As an example, an instant write flag of logic “1” represents that the data to be written on the storage device 200 is stored in the CMB 216, and an instant write flag of logic “0” represents that the data to be written on the storage device 200 is not stored in the CMB 216.

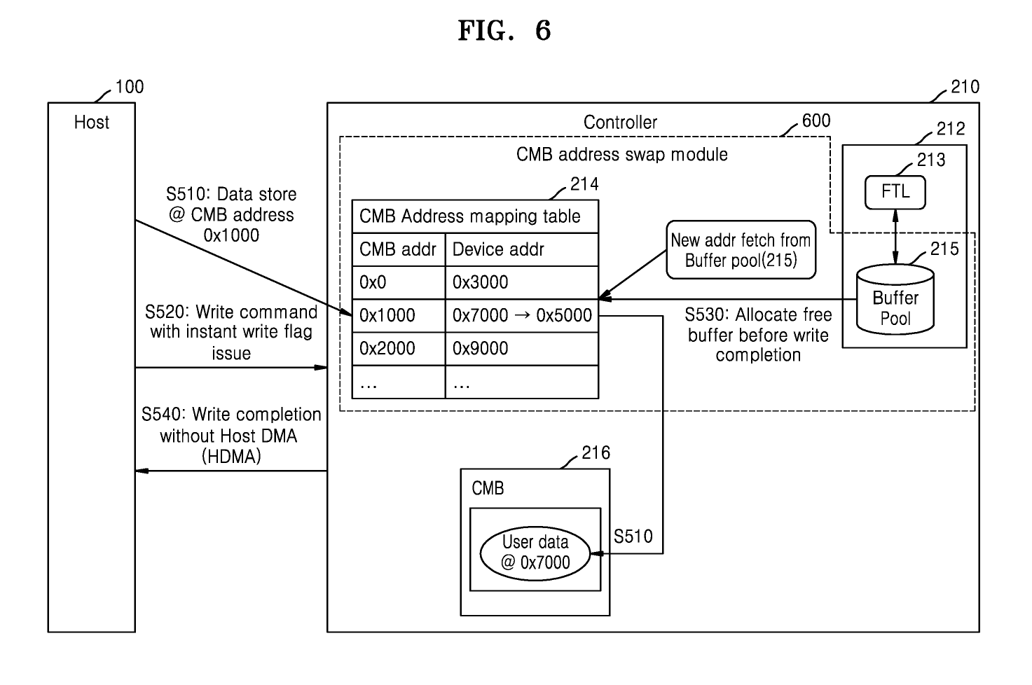

The storage device 200 determines whether the WDS is supported, allocates an address of a free buffer area in the CMB 216 in response to the instant write flag when the WDS is supported, and updates the address of the allocated free buffer area in the CMB address mapping table (S530). The storage device 200 may transfer a write command completion to the host 100 after updating the CMB address mapping table (S540). The operation of updating the CMB address mapping table will be described below with reference to FIG. 6.

Referring to FIG. 6, the storage device 200 may store user data to be written on the storage device 200 in a memory area of a first CMB address 0x1000 according to data communications performed with the host 100 (S510). The storage device 200 stores the user data in a memory area of a first device address 0x7000 in the CMB 216, wherein the first device address 0x7000 is mapping on the first CMB address 0x1000 (S510). The host 100 may issue a write command including WDS and an instant write flag to the controller 210 (S520).

The controller 210 may refer to the CMB address mapping table in response to the instant write flag. The CMB address mapping table is stored in the SRAM 214 of the controller 210. The controller 210 may identify that the first CMB address 0x1000 targeted by the host 100 is allocated to the first device address 0x7000 in the CMB 216. The controller 210 may fetch a new address (e.g., 0x5000) from a buffer pool 215 that stores addresses of the free buffer area in the CMB 216, by using a flash transformation table 213 (FTL) of the processor 212 (S530). The controller 210 may allocate the new fetched address as a second device address 0x5000, and may update the CMB address mapping table so that the second device address 0x5000 may be pointed to the first CMB address 0x1000 (S530). Then, the first CMB address 0x1000 targeted by the host 1000 will be converted to the second device address 0x5000 in the CMB 216.

The controller 210 may transfer the write command completion to the host 100 after updating the CMB address mapping table (S540). The controller 210 may transfer the write command completion to the host 100 without performing the HDMA operation.

The CMB address mapping table stored in the SRAM 214 and the buffer pool 215 included in the processor 212 may configure a CMB address swap module 600. The CMB address swap module 600 may be implemented as firmware or software including a module, procedure, or function performing functions or operations of converting the CMB address targeted by the host 100 to a new device address allocated to the CMB 216, in order to make the storage device 200 instantly issue the write command completion to the host 100 without performing the HDMA operation. The functions of the CMB address swap module 600 may be controlled by software or automated by hardware.

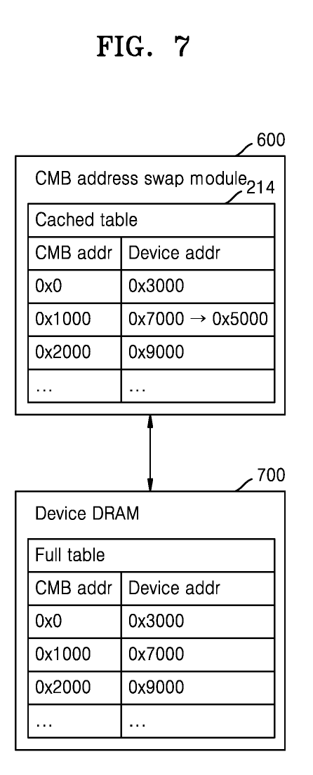

Referring to FIG. 7, the CMB address mapping table used in operations of the CMB address swap module 600 may be stored in a memory device 700. The memory device 700 may be implemented as DRAM. The memory device 700 may store an entire CMB address mapping table (i.e., ‘full table’). The CMB address swap module 600 may store some subset of the entire CMB address mapping table stored in the memory device 700 (i.e., ‘cached table’), in SRAM 214, wherein the some of the CMB address mapping table is related to the CMB address targeted by the host 100. Accordingly, the SRAM 214 may be used to cache the CMB address mapping table.

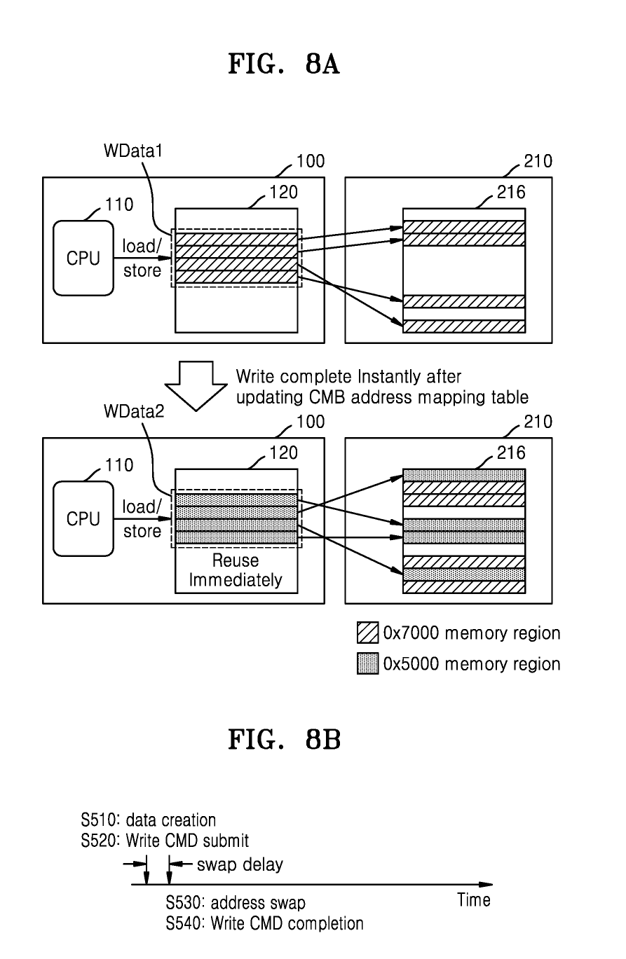

Referring to FIG. 8A, the first data WData1 generated by the first processing of the CPU 110 in the host 100 is stored in the host memory 120, and the first data WData1 in the host memory 120 may be transferred to the controller 210 with the first CMB address 0x1000. The controller 210 may store the first data WData1 in the memory area 420 of the first device address 0x7000 of the CMB 216 matching with the first CMB address 0x1000.

The controller 210 allocates the second device address 0x5000 of the free buffer area of the CMB 216, and may update the CMB address mapping table to make the second device address 0x5000 point to the first CMB address 0x1000. The controller 210 may transfer the write command completion to the host 100 after updating the CMB address mapping table.

After receiving the write command completion, the host 100 may store the second data WData2 generated by the second processing in the host memory 120 and transfer the second data 410 in the host memory 120 to the controller 210 with the first CMB address 0x1000. That is, the host 100 may again use the first CMB address 0x1000. The controller 210 may store the second data WData2 in the memory area 420 of the second device address 0x5000 of the CMB 216 matching with the first CMB address 0x1000.

Referring to FIG. 8B, the write command completion may have a time delay according to the address swapping for updating the CMB address mapping table, e.g., latency of nearly 0. The short latency of the write command completion may improve high speed performance of the host system 10.

In FIG. 8C, it will be assumed that the write operation of the first data WData1 according to the write command of the host 100 is performed with, e.g., 3.2 GB/s bandwidth.

The write operation of the first data WData1 may include a transfer operation from the host memory 120 to the memory area of the first device address 0x7000 of the CMB 216 via the external interface 300 with 3.2 GB/s bandwidth, and a transfer operation from the memory area of the first device address 0x7000 of the CMB 216 to the NVM 220 via the NVM interface 230 with 3.2 GB/s bandwidth. Accordingly, a buffer bandwidth required by the CMB 216 is 6.4 GB/s (=3.2 GB/s×2). The buffer bandwidth required by the CMB 216 is less than the bandwidth (12.8 GB/s) of the CMB 216 required according to the HDMA operation as shown in FIG. 4C. Accordingly, efficiency of the memory function of the CMB 216 may improved.

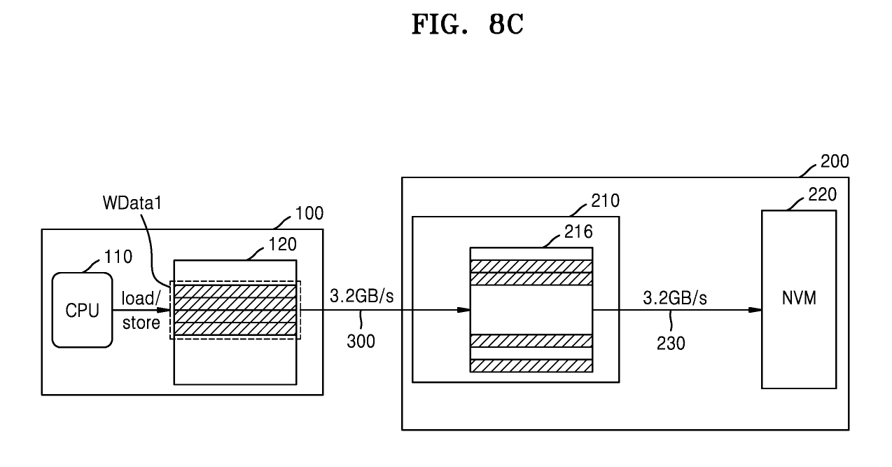

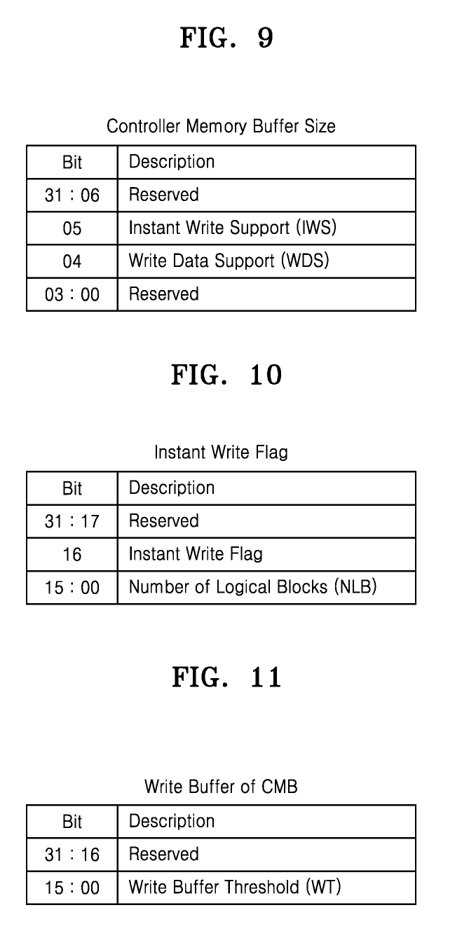

FIG. 9 is a diagram illustrating a controller memory buffer size according to an embodiment.

Referring to FIG. 9, the controller memory buffer size may include four bits (00 to 03) of a first reserved area, one bit (04) indicating the WDS, one bit (05) indicating instant write support (IWS), and 26 bits (06 to 31) of a second reserved area. When the bit supporting the WDS is logic “1”, the controller 210 (see FIG. 1) may provide the data in the CMB 216 as the data corresponding to the command for transferring the data from the host 100 to the controller 210. When the bit supporting the WDS is logic “0”, the data corresponding to the command for transferring the data from the host 100 to the controller 210 is transferred from the host memory 120. When the bit supporting the IDS is set as logic “1”, the controller 210 may support the instant write completion when the CMB 216 is used as the write buffer.

FIG. 10 is a diagram illustrating an instant write flag according to an embodiment.

Referring to FIG. 10, the instant write flag may include the number of logic blocks (NLB) of 16 bits (00 to 15), one bit (16) indicating instant writing via the Instant Write Flag, and 15 bits (17 to 31) of a reserved area. A field indicating the NLB denotes the number of logic blocks to be written. When the bit indicating the instant writing is logic “1”, the write data is stored in the CMB area. The bit instructing the instant writing may be optionally added according to an embodiment.

FIG. 11 is a diagram illustrating a write buffer threshold according to an embodiment.

Referring to FIG. 11, the write buffer threshold may include 16 bits (00 to 15) for setting the write buffer threshold (WT), and 16 bits (16 to 31) of a reserved area. A field setting the WT may indicate a threshold value of the free buffer area in the CMB 216 in a range of 0 to 99 percentile.

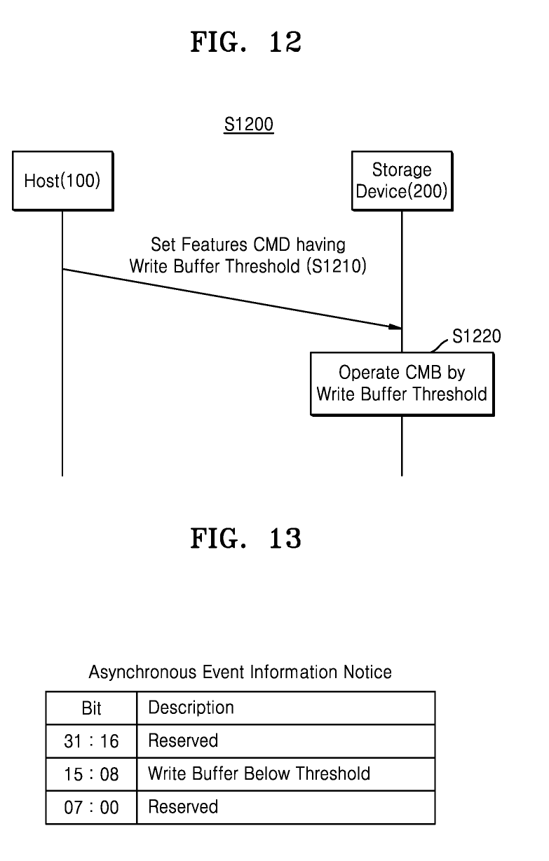

FIG. 12 is a diagram illustrating a method of requesting a write buffer threshold, according to an embodiment.

Referring to FIG. 12, the method of requesting the write buffer threshold (S1200) performed by the CMB 216 may be performed as follows.

The host 100 may transfer a set features CMD having the write buffer threshold to the storage device 200 (S1210). The storage device 200 may operate by setting the free buffer area of the CMB 216 as the write buffer threshold (S1220).

FIG. 13 is a diagram illustrating notification of asynchronous event information according to an embodiment.

Referring to FIG. 13, the asynchronous event information notification may include 8 bits (00 to 07) of a first reserved area, 8 bits (08 to 15) indicating Below Write Buffer Threshold, and 26 bits (06 to 31) of a second reserved area. The field indicating the Below Write Buffer Threshold may include bits representing that the available free buffer area of the CMB 216 becomes lower than the set write buffer threshold. The field representing the Below Write Buffer Threshold may be inserted in asynchronous CMD completion message.

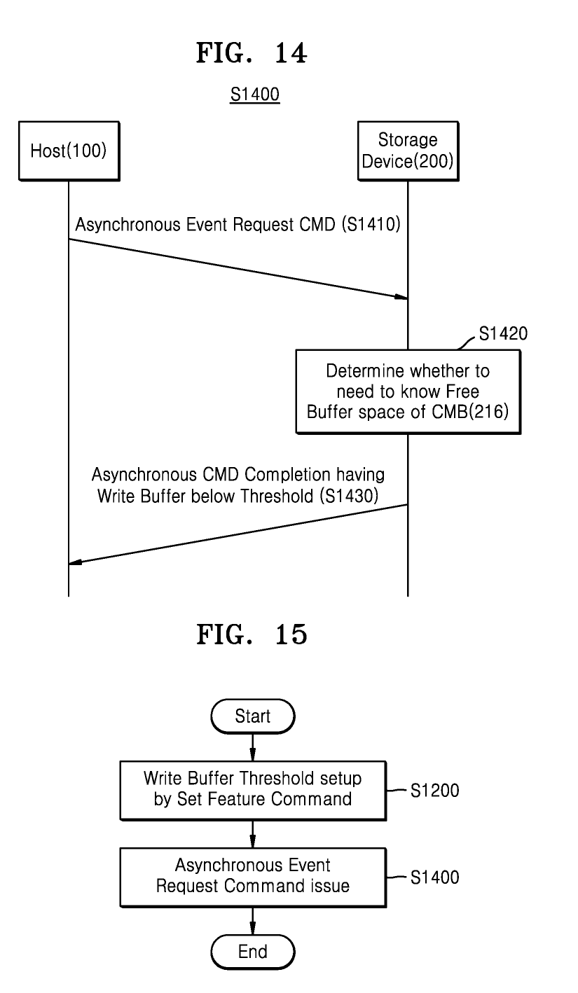

FIG. 14 is a diagram illustrating a method of requesting notification of asynchronous event information, according to an embodiment.

Referring to FIG. 14, the method of requesting the asynchronous event information notification (S1400) may be performed as follows.

The storage device 200 may fetch the asynchronous event request CMD issued to the SQ 1110 of the host 110 (S1410). The storage device 200 may determine whether to identify the free buffer area of the CMB 216 (S1420). When it is determined that the free buffer area of the CMB 216 is under the set write buffer threshold, the storage device 200 may insert Below Write Buffer Threshold in the asynchronous CMD completion. The storage device 200 may transfer the asynchronous CMD completion having Below Write Buffer Threshold to the host 100 (S1430).

FIG. 15 is a flowchart illustrating a method of setting a write buffer threshold, according to an embodiment.

Referring to FIG. 15, the method of setting the write buffer threshold may include performing the method of requesting the write buffer threshold of the CMB 216 (S1200) illustrated with reference to FIG. 12, and performing the method of requesting the asynchronous event information notification (S1400) illustrated in FIG. 14.

The method of requesting the write buffer threshold (S1200) may include transferring the set features CMD having the write buffer threshold from the host 100 to the storage device 200 (S1210). In addition, the storage device 200 may operate after setting the free buffer area of the CMB 216 as the write buffer threshold (S1220). In the method of requesting the asynchronous event information notification (S1400), the storage device 200 may fetch the asynchronous event request CMD issued to the SQ 1110 of the host 100 (S1410). In addition, when it is determined that the free buffer area of the CMB 216 is below the set write buffer threshold, the storage device 200 may transfer asynchronous CMD completion having Below Write Buffer Threshold to the host 100 (S1430).

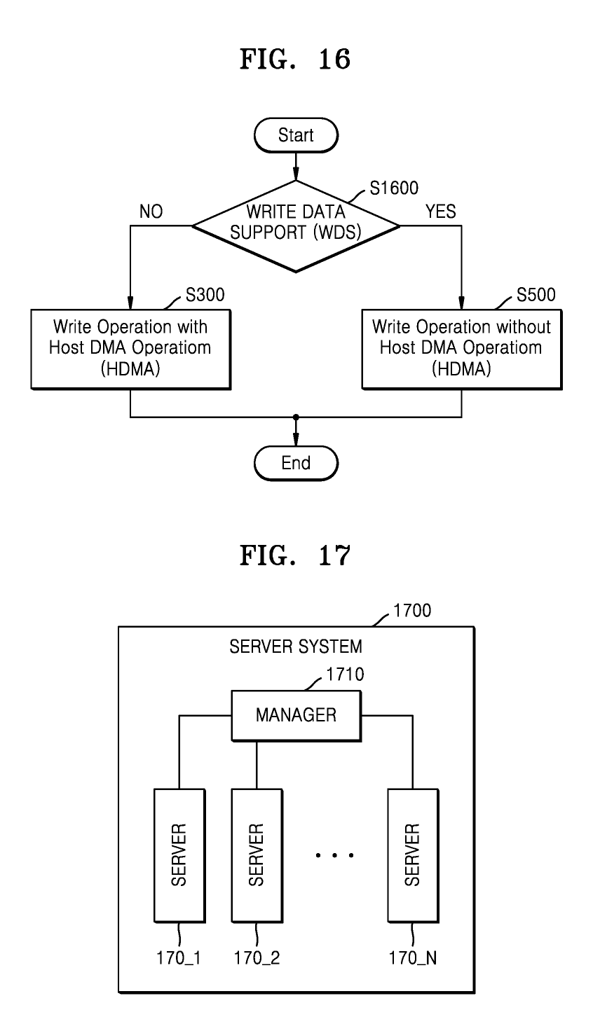

FIG. 16 is a flowchart illustrating a write operation of a third example executed in the host system 10 of FIG. 1, according to an embodiment.

Referring to FIG. 16, the host system 10 may determine whether to support the WDS (S1600). As a result of determination, when the bit indicates the WDS is logic “0”, that is, the WDS is not supported (No), the process proceeds to operation S300. As a result of determination, when the bit indicates the WDS is logic “1”, that is, the WDS is supported (Yes), the process proceeds to operation S500. In operation S300, the write operation including the HDMA operation illustrated above with reference to FIG. 3 may be performed. Operation S300 may include an operation of generating data to be written on the storage device 200 in the host 100 (S310), an operation of issuing a write command by the host 100 to the storage device 200 (S320), an operation of fetching the write command of the SQ 1110 by the storage device 200 and triggering the HDMA operation (S330), and an operation of transferring the write command completion to the host 100 (S340).

Operation S500 may perform the write operation without performing the HDMA operation illustrated with reference to FIG. 5. Operation S500 may include an operation of issuing a write command including an instant write flag by the host 100 to the storage device 200 (S520), an operation of allocating an address of the free buffer area of the CMB 216 by the storage device 200 in response to the instant write flag, and updating the address of the allocated free buffer area to the CMB address mapping table (S530), and an operation of transferring the write command completion from the storage device 200 to the host 100 (S540).

FIG. 17 is a block diagram of a server system 1700 according to an embodiment.

Referring to FIG. 17, the server system 1700 may include a plurality of servers 170_1, 170_2, . . . , 170_N. The plurality of servers 170_1, 170_2, . . . , 170_N may be connected to a manager 1710. The plurality of servers 170_1, 170_2, . . . , 170_N may be identical or similar to the host system 10 described above. In each of the plurality of servers 170_1, 170_2, . . . , 170_N, the host may issue the WDS, the instant write flag, the write buffer threshold, and/or the write command. The storage device may determine whether to support the WDS, fetch the write command including the instant write flag when the WDS is supported, update the address mapping table regarding the CMB without performing the HDMA operation in response to the fetched write command, and generate write command completion corresponding to the write command. When the WDS is not supported, the storage device may generate the write command completion after performing the HDMA operation in the CMB in response to the write command issued by the host. The storage device may receive a threshold value of the free buffer area in the CMB as a write buffer threshold from the host, and set the free buffer area in the CMB as the write buffer threshold. The storage device may notify the host that the free buffer area in the CMB is below the write buffer threshold.

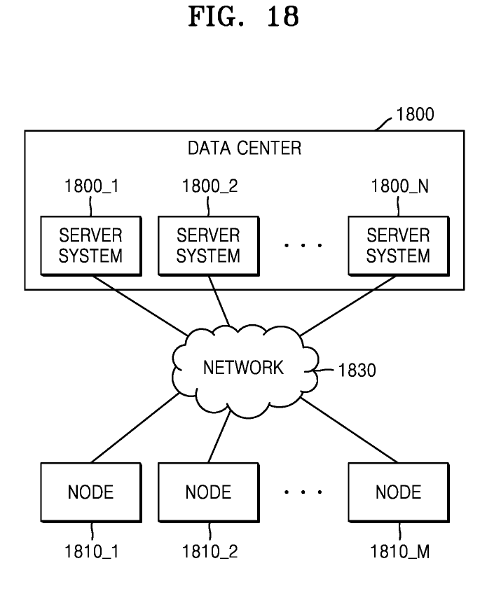

FIG. 18 is a block diagram of a data center 1800 according to an embodiment.

Referring to FIG. 18, the data center 1800 may include a plurality of server systems 1800_1, 1800_2, . . . , 1800_N. Each of the plurality of server systems 1800_1, 1800_2, . . . , 1800_N may be similar to or the same as the server system 1700 illustrated in FIG. 17. The plurality of server systems 1800_1, 1800_2, . . . , 1800_N may communicate with various nodes 1810_1, 1810_2, . . . , 1810_M via a network 1830 such as Internet. For example, the nodes 1810_1, 1810_2, . . . , 1810_M may be one of client computers, other servers, remote data centers, and storage systems.

In each of the plurality of server systems 1800_1, 1800_2, . . . , 1800_N and/or the nodes 1810_1, 1810_2, . . . , 1810_M, the host may issue a WDS, an instant write flag, a write buffer threshold, and/or a write command. The storage device may determine whether to support the WDS, fetch the write command including the instant write flag when the WDS is supported, update the address mapping table regarding the CMB without performing the HDMA operation in response to the fetched write command, and generate write command completion corresponding to the write command. When the WDS is not supported, the storage device may generate the write command completion after performing the HDMA operation in the CMB in response to the write command issued by the host. The storage device may receive a threshold value of the free buffer area in the CMB as a write buffer threshold from the host, and set the free buffer area in the CMB as the write buffer threshold. The storage device may notify the host that the free buffer area in the CMB is below the write buffer threshold.

While aspect of the present disclosure have been particularly shown and described with reference to embodiments thereof, it will be understood that various changes in form and details may be made therein without departing from the spirit and scope of the following claims.

1. A method of operating a storage device, the method comprising:
receiving a write command issued by the host;
updating an address mapping table regarding a controller memory buffer (CMB) of the storage device in response to the write command;
generating a write command completion message corresponding to the write command, performed by the CMB, without performing a host direct memory access (HDMA) operation; and
transmitting the write command completion message to the host.

2. The method of claim 1, wherein the write command issued by the host comprises an instant write flag.

3. The method of claim 2, wherein the instant write flag indicates that data of a first CMB address targeted by the host is stored in a first device address in the CMB.

4. The method of claim 3, wherein the updating comprises:
allocating a second device address of a free buffer area in the CMB; and
updating the address mapping table in which the first CMB address points to the second device address.

5. The method of claim 1, further comprising:
receiving a threshold value of a free buffer area in the CMB as a write buffer threshold from the host.

6. The method of claim 5, further comprising:
receiving a set features command (CMD) including the write buffer threshold from the host; and
setting the free buffer area in the CMB as the write buffer threshold.

7. The method of claim 5, further comprising:
notifying the host that the free buffer area in the CMB is below the write buffer threshold.

8. The method of claim 7, wherein the notifying comprises generating asynchronous command completion message including a Below Write Buffer Threshold in response to an asynchronous event request CMD issued by the host.

9. A method of operating a storage device, the method comprising:
determining whether to support write data support (WDS) of a write command provided by a host;
in response to determining that WDS is supported, generating a write command completion message, performed by a controller memory buffer (CMB) of the storage device, corresponding to the write command issued by the host without performing a host direct memory access (HDMA) operation and in response to determining that WDS is not supported, generating a write command completion message after performing the HDMA operation in the CMB in response to the write command issued by the host; and
transmitting the write command completion message to the host.

10. The method of claim 9, wherein the generating the write command completion message, performed by the controller memory buffer (CMB) of the storage device, corresponding to the write command issued by the host without performing the HDMA operation comprises:
updating an address mapping table regarding the CMB by using a free buffer area in the CMB.

11. The method of claim 9, further comprising:
receiving a threshold value of a free buffer area in the CMB as a write buffer threshold from the host.

12. The method of claim 11, further comprising:
setting the free buffer area in the CMB as the write buffer threshold.

13. The method of claim 9, further comprising:
notifying the host that the free buffer area in the CMB is below the write buffer threshold.

14. The method of claim 9, wherein the HDMA operation comprises:
fetching the write command from the host;
storing data to be written on the storage device from the host, in the CMB; and
copying the data stored in the CMB to a write buffer.

15. A method of issuing a command, performed by a host, the method comprising:
issuing a write command including write data support (WDS) to a storage device; and
receiving a write command completion corresponding to the write command,
wherein the WDS is a storage operation to store data based on manipulation of an address of the data in a controller memory buffer (CMB) of the storage device.

16. The method of claim 15, wherein the write command comprises an instant write flag.

17. The method of claim 15, further comprising:
issuing to the storage device a synchronous command having a write buffer threshold of a free buffer area, to update an address mapping table regarding a controller memory buffer (CMB) by using the free buffer area in the CMB in response to the write command.

18. The method of claim 17, wherein the synchronous command is a set features command.

19. The method of claim 17, further comprising:
issuing an asynchronous command to the storage device; and
receiving an asynchronous command completion message corresponding to the asynchronous command including a Below Write Buffer Threshold.

20. The method of claim 19, wherein the asynchronous command is an asynchronous event request command.

21-29. (canceled)
